(19) United States
(12) Patent Application Publication
(10) Pub. No.: US 2026/0298627 A1
(43) Pub. Date: Oct. 1, 2026

(54) SPECTRAL REFLECTOMETRY SENSOR FOR A FEEDBACK LOOP IN THE POLISHING OF MATERIAL SAMPLES

(71) Applicant: Georgia Tech Research Corporation, Atlanta, GA (US)

(72) Inventors: Styler Theron Goring, Atlanta, GA (US); Aaron Stebner, Atlanta, GA (US)

(21) Appl. No.: 19/578,646

(22) Filed: Mar. 25, 2026

Related U.S. Application Data
(60) Provisional application No. 63/777,456, filed on Mar. 25, 2025.

(51) Int. Cl. G01B 11/30

(52) U.S. Cl. CPC G01B 11/303

(57) ABSTRACT

A machine and method for measuring surface roughness of a material during polishing for material characterization. The machine comprises a stage for supporting the material, a laser diode generating a laser beam directed toward the stage, a beamshaper for shaping the laser beam, a beamsplitter for splitting the beam into portions with one portion directed toward the material, a photodetector for measuring intensity of reflective light from the material surface, and a control system programmed to create maps of surface roughness based on measured reflective light intensity at different positions. The method comprises polishing with successive grits, measuring surface roughness using reflective light to create maps after each polishing step, and comparing the maps to determine changes in reflected light. The feedback loop automates polishing without predetermined recipes and enables error detection during the polishing process.

### CROSS-REFERENCE TO RELATED APPLICATIONS

This application claims the benefit of U.S. Provisional Application No. 63/777,456, filed Mar. 25, 2025, the entirety of which is incorporated herein by reference.

### FIELD OF THE INVENTION

The present disclosure relates to a machine, method, and system for preparing solid material samples, including metallic, ceramic, polymeric, and glassy materials, for material characterization.

### BACKGROUND

In order to perform material characterization on solid material samples, such as metallic, ceramic, polymeric, or glassy specimens, the surface of the sample must be extremely smooth. That is typically prepared through first grinding with silicon carbide or aluminum oxide sandpaper, and then with polishing solutions. In the current process for material characterization, a known or generic recipe must be followed for how long each grit/solution should be used. That process, however, does not work well for novel materials, where no recipe yet exists.

### SUMMARY

In one aspect, the present disclosure provides a machine for measuring surface roughness of a material during polishing. The machine comprises a stage configured to support the material; a laser diode configured to generate a laser beam and direct the laser beam toward the stage; a beamshaper configured to shape the laser beam from the laser diode; a beamsplitter configured to split the laser beam into a first portion and a second portion, the second portion being directed toward the material on the stage; a photodetector configured to measure intensity of reflective light from a surface of the material; and a control system including at least a processor and memory programmed to create a map of surface roughness based on the measured intensity of reflective light at different positions on the material.

In another aspect, the present disclosure provides a method for automated preparation of a material for material characterization. The method comprises polishing a surface of the material using a first grit; measuring a surface roughness of the surface of the material using reflective light to create a first map; polishing the surface of the material using a second grit; measuring the surface roughness of the surface of the material after polishing with the second grit to create a second map; and comparing the first map and the second map to determine whether there is a change in reflected light.

This summary is not intended to identify essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1A is a schematic view of an exemplary machine for measuring surface roughness of a material during polishing, according to the present disclosure.

FIG. 1B is a detailed view of a set of filters for use with the machine of FIG. 1A, according to the present disclosure.

FIG. 2 is a graphic drawing illustrating the types of reflections from a laser beam off of a material sample and to a reflective light detector.

FIG. 3 is a flowchart of a feedback loop for automated polishing control, according to the present disclosure.

FIG. 4 is a graph of reflected energy of a sample versus the amount of time the sample is polished, showing that a change in surface roughness can be tracked.

FIG. 5 is a graph of counts versus the reflective energy of a sample, showing that a change in surface roughness can be tracked.

FIG. 6 is a graph of the normalized reflected energy of a sample over time.

FIG. 7 illustrates a data relationship showing that using the machine, method, and system of the present disclosure, errors in the polishing process can be detected.

FIG. 8 illustrates a data relationship showing a comparison of surface roughness evolution for different materials during polishing.

FIG. 9 illustrates a data relationship showing the surface evolution during a single polishing process.

FIG. 10 illustrates a data relationship showing a comparison of recipe-based and feedback-controlled polishing methods according to the present disclosure.

### DETAILED DESCRIPTION

It is to be understood that the figures and descriptions of the present disclosure may have been simplified to illustrate elements that are relevant for a clear understanding of the present disclosure, while eliminating, for purposes of clarity, other elements found in material polishing and characterization. Those of ordinary skill in the art will recognize that other elements may be desirable and/or required in order to implement the present disclosure. However, because such elements are well known in the art, and because they do not facilitate a better understanding of the present disclosure, a discussion of such elements is not provided herein. It is also to be understood that the drawings included herewith only provide diagrammatic representations of the presently preferred structures of the present disclosure and that structures falling within the scope of the present disclosure may include structures different than those shown in the drawings. Reference will now be made to the drawings wherein like structures are provided with like reference designations.

Before explaining at least one embodiment in detail, it should be understood that the inventive concepts set forth herein are not limited in their application to the construction details or component arrangements set forth in the following description or illustrated in the drawings. It should also be understood that the phraseology and terminology employed herein are merely for descriptive purposes and should not be considered limiting. It should further be understood that any one of the described features may be used separately or in combination with other features. Other devices, systems, methods, features, and advantages will be or become apparent to one with skill in the art upon examining the drawings and the detailed description herein. It is intended that all such additional devices, systems, methods, features, and advantages be protected by the accompanying claims.

In general, the present disclosure provides a machine, method, and system for monitoring, measuring, and providing feedback regarding the smoothness of a surface of a sample during polishing of the sample in preparation for material characterization of the sample. The present disclosure is applicable to semi-opaque and opaque solid materials prepared through abrasive grinding and/or polishing, including but not limited to metallic materials (such as iron-based alloys, aluminum-based alloys, and other metal alloys), ceramic materials, polymeric materials, and glassy materials. To perform surface-sensitive characterization techniques, samples are polished prior to characterization. Polishing processes may comprise using finer and finer abrasives, each needing to remove all the abrasion artifacts, such as scratches, of the previous step.

The machine, method, and system of the present disclosure automatically measure the progress of the polishing of a material sample. The present disclosure shows that measuring spectral reflection off a sample can gauge progress made during polishing, and the measurements can serve as a control loop to automate the polishing process. Additionally, recipes for polishing can be created quantitatively and used in automated systems without control loops. The machine, method, and system of the present disclosure also allows for catching any errors during the polishing process. By measuring the light that is or is not reflected off of a sample, the progress of the polishing can be quantized, allowing for a more automated process. That feedback system for polishing progress allows the adaptation and creation of recipes for new compositions.

In some embodiments, the present disclosure can be used to monitor the progress of a sample through the polishing and grinding process of sample preparation, prior to material characterization techniques such as optical microscopy, hardness testing, scanning electron microscopy, x-ray diffraction, and the like. The machine or instrument of the present disclosure may be configured to measure the relative surface roughness of a material to help quantify surface characteristics such as peaks, valleys, and overall texture. In certain implementations, a stylus-type instrument may physically trace the surface, with the stylus moving vertically over the surface's peaks and valleys while changes in height are recorded to create a profile. In the present disclosure, however, a non-contact optical approach is employed.

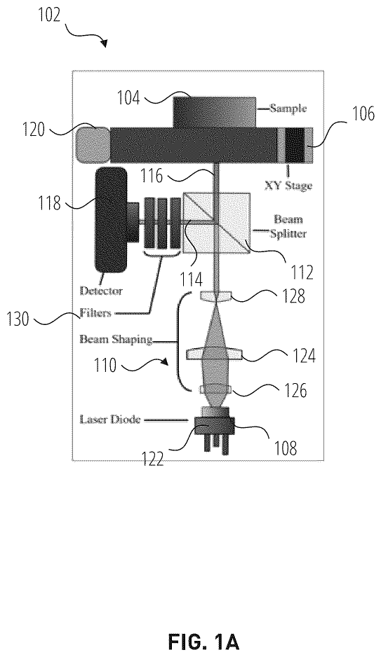

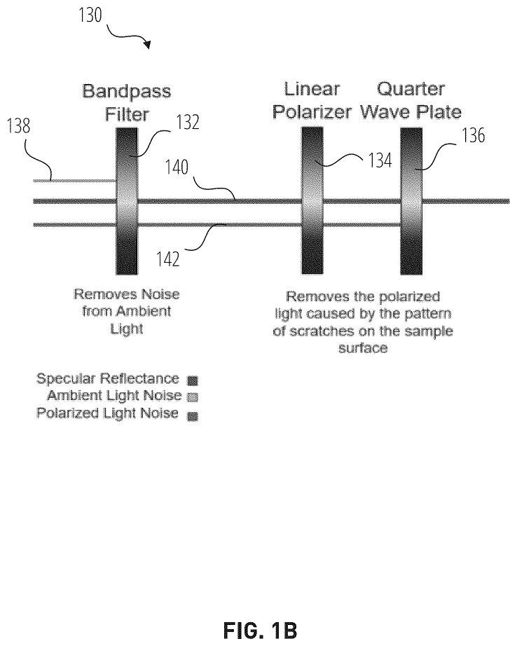

FIG. 1A is a schematic view of an exemplary machine 102 for measuring surface roughness of a material during polishing, according to the present disclosure. The machine 102 comprises a light source 108, a beamshaper 110, a beamsplitter 112, a stage 106, a set of filters 130, and a photodetector 118, arranged in an optical path as described below.

The light source 108 is configured to generate a collimated beam of light and direct the beam toward the stage 106. In some embodiments, the light source 108 emits light having a wavelength between 180 nm and 850 nm, encompassing both the ultraviolet and visible spectra. The light source 108 may comprise a laser diode, a xenon lamp with beam shaping optics configured to collimate, a deuterium arc lamp with beam shaping optics configured to collimate, a gas laser, a solid state laser, or a femtosecond laser. In one exemplary embodiment, the light source 108 comprises a laser diode emitting a laser beam having a wavelength of approximately 405 nm. The light source 108 may be mounted in a mount 122 driven with a controller, which maintains stable operating conditions for the light source 108 during measurement.

The beamshaper 110 is configured to shape the beam of light from the light source 108. In some embodiments, the beamshaper 110 comprises a collimating lens 124, a first plano-convex lens 126, and a second plano-convex lens 128. The collimating lens 124 collimates the diverging beam emitted by the light source 108, and the first plano-convex lens 126 and the second plano-convex lens 128 further shape the beam to achieve a desired beam profile for illuminating the sample surface. In embodiments where the light source 108 comprises a lamp (such as a xenon lamp or deuterium arc lamp), the beamshaper 110 includes beam shaping optics configured to collimate the light output from the lamp.

The beamsplitter 112 is configured to split the beam of light into a first portion 114 and a second portion 116. In some embodiments, the beamsplitter 112 comprises a 50:50 nonpolarizing beamsplitter cube. The second portion 116 is directed downward toward the material 104 on the stage 106, where it reflects off the surface of the material 104. The reflected light returning from the material surface travels back through the beamsplitter 112, which redirects the reflected light along the detection optical path. The first portion 114 of the beam is directed from the beamsplitter 112 through the set of filters 130 and toward the photodetector 118. As the first portion 114 passes through the set of filters 130, the bandpass filter 132 removes ambient light noise 138, and the linear polarizer 134 and the quarter-wave plate 136 together form a circular polarization setup that removes polarized light noise 142 caused by the pattern of scratches on the sample surface. In that manner, the set of filters 130 isolates the spectral reflectance 140 signal carried by the first portion 114 before it reaches the photodetector 118 for intensity measurement.

The material 104 is supported on the stage 106. In some embodiments, the stage 106 comprises an X-Y motion stage or an X-Y-Z motion stage configured for precise and repeatable movements. The X-Y motion stage enables two-dimensional scanning of the material 104 across the beam of light, while the X-Y-Z motion stage additionally provides vertical positioning capability for focus adjustment or accommodating samples of varying thickness. The stage 106 is movable to scan the material 104 across the beam of light, enabling measurement of surface roughness at different positions on the material 104. The material 104 may be positioned face down in a holder, which is attached to the stage 106, with the beam of light directed upward from below.

A set of filters 130 is positioned between the beamsplitter 112 and the photodetector 118 along the detection optical path. In some embodiments, as shown in FIG. 1B, the set of filters 130 comprises a circular polarization setup including a linear polarizer 134 and a quarter-wave plate 136. The linear polarizer 134 and the quarter-wave plate 136 together form a circular polarization setup that removes the polarized light caused by the pattern of scratches on the sample surface, thereby improving measurement accuracy. The set of filters 130 further comprises a bandpass filter 132 that removes noise from ambient light. In this configuration, the bandpass filter 132, the linear polarizer 134, and the quarter-wave plate 136 work together to isolate the spectral reflectance 140 signal from noise sources including ambient light noise 138 and polarized light noise 142.

The photodetector 118 is configured to measure the intensity of reflective light from the surface of the material 104. In some embodiments, the photodetector 118 is an amplified silicon photodetector. The photodetector 118 outputs a current based on the intensity of light received, which is proportional to the specular reflectance from the sample surface. A smoother surface reflects more light specularly, resulting in a higher detector output, while a rougher surface diffuses more light, resulting in a lower detector output.

The machine 102 further comprises a control system 120 including at least a processor and memory programmed to create a map of surface roughness based on the measured intensity of reflective light at different positions on the material 104. In some embodiments, the control system 120 is connected to the stage 106 and the photodetector 118, and controls the movement of the stage 106 while simultaneously recording detector readings. In certain implementations, the control system 120 comprises an in-house software program connected to a drive controller for the stage 106 and records the photodetector readings through an oscilloscope or similar data acquisition device. The control system 120 is further configured to compare a first map created after a first polishing step with a second map created after a second polishing step to determine a change in surface roughness.

A map of surface roughness can be created by moving the material 104 across the beam of light via the stage 106, while recording the current output of the photodetector 118, to show the strength of the reflection recorded at each position. As smoother surfaces reflect more light, this scan can be repeated after each polishing or grinding step, such as the next higher grit, for a period of time. In some embodiments, the entire surface of the sample can be scanned at regular intervals. The maps after each scan can then be compared to see the amount of changed light due to the now smoother surface. By changing the position of the sample, a grid of the specular reflectance at different portions of the sample can be created, giving a relative surface roughness value at various points.

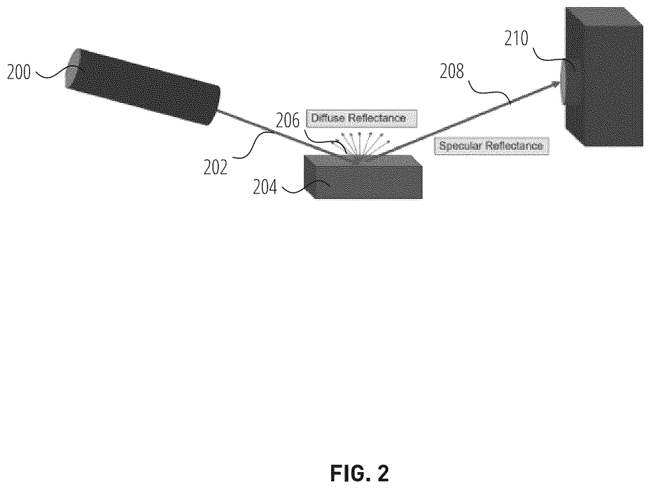

FIG. 2 is a graphic drawing illustrating the types of reflections from a beam of light off of a material sample and to a reflective light detector. FIG. 2 depicts a light source 200 directing a beam of light 202 toward a material sample 204. Upon reflection, the light separates into two components: specular reflectance 208 and diffuse reflectance 206.

Specular reflectance 208 represents the portion of the reflected light that reflects at the angle of incidence, as would occur from a perfectly smooth, mirror-like surface. The smoother the surface, the greater the proportion of specular reflectance 208. Diffuse reflectance 206 represents the portion of the reflected light that scatters in various directions due to surface irregularities such as scratches, peaks, and valleys. The rougher the surface, the more the light is diffused, and the specular reflectance 208 lowers.

The material sample 204 is shown with surface features representing peaks and valleys, which contribute to diffuse reflectance 206. A light detector 210 receives the specular reflectance 208. The intensity of the specular reflectance 208, in which the diffuse reflection is effectively lost from the detection path, is recorded for each point on the material sample 204 by moving the sample with the stage. This relationship between surface roughness and specular reflectance forms the physical basis for the measurement technique of the present disclosure.

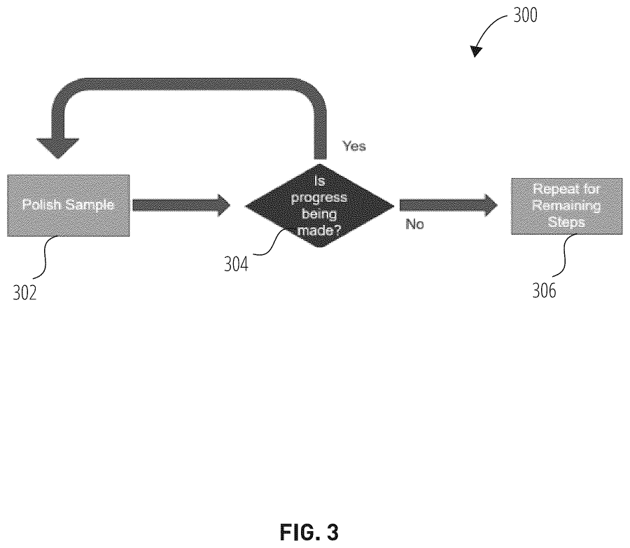

FIG. 3 is a flowchart illustrating a method 300 for automated polishing control according to the present disclosure. The method 300 begins at step 302 in which the sample is polished using a current grit or polishing solution. After polishing for a period of time, the sample is placed on the scanning stage for profiling.

At step 304, the system determines whether progress is being made by comparing maps of surface roughness taken at different intervals. If progress is being made (i.e., the reflected light is increasing, indicating a smoother surface), the process returns to step 302 where polishing continues with the current grit. If no further progress is being made (i.e., there is no change in the reflected light, indicating that the current grit has reached its optimal or maximum smoothness achievable), the process proceeds to step 306 where it repeats for remaining polishing steps, moving to the next grit. That feedback loop can be repeated for remaining polishing steps until the sample surface has achieved the desired smoothness for material characterization.

At regular intervals during the polishing process, after one or more polishing stages have been completed, the sample can be placed on the scanning stage as part of the machine, method, and system of the present disclosure. The scanning stage allows the sample to be moved in a controlled manner relative to the laser beam, enabling a quick scan of the sample surface to be recorded. That placement of the sample on the scanning stage facilitates the measurement of surface roughness across the entire sample surface, providing data for comparison between polishing stages.

The map can have the same orientation for each scan, so that the progress at each point can be observed. That can be beneficial for samples with different properties at different points, where the progress can differ based on material properties.

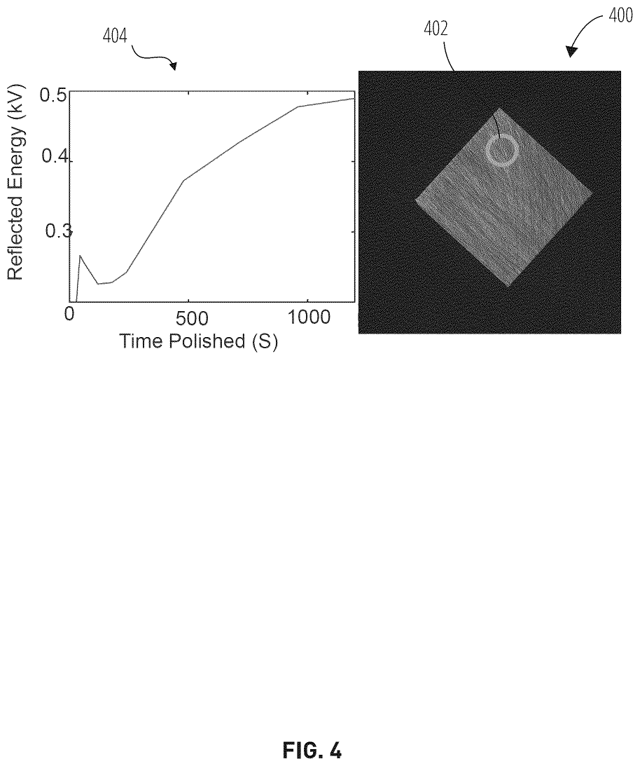

FIG. 4 depicts a graph 404 showing reflected energy of a sample 400 versus the amount of time the sample 400 is polished. A portion of the sample 402 is measured, and the graph 404 plots reflected energy, measured in kilovolts (kV), versus time polished, measured in seconds (S).

As shown in FIG. 4, the reflected energy increases as polishing time increases, demonstrating that the surface becomes smoother over time. The curve eventually plateaus, indicating that the current grit has reached its maximum effectiveness and the sample is ready for the next grit application. This graphical representation demonstrates the ability of the machine and method of the present disclosure to track changes in surface roughness over time as the sample is polished.

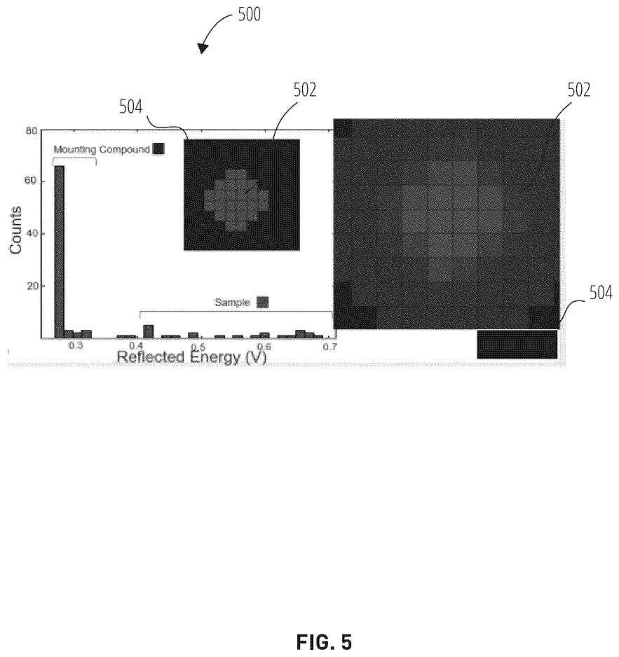

FIG. 5 is a graph 500 of counts versus the reflective energy of a sample 502. The graph 500 illustrates a histogram distribution showing the distribution of reflected energy readings across the surface of the sample 502. Two distinct regions are visible: the sample 502 region and the mounting compound region 504. The reflected energy readings from the surface of the sample 502 are distinguishable from the readings obtained from the mounting compound 504 surrounding the sample 502, demonstrating the spatial resolution capability of the measurement system.

The vertical axis represents counts, and the horizontal axis represents reflected energy measured in volts (V). The distribution of counts at various reflected energy levels provides information about the uniformity of the surface finish and can be used to identify when the surface roughness has stabilized.

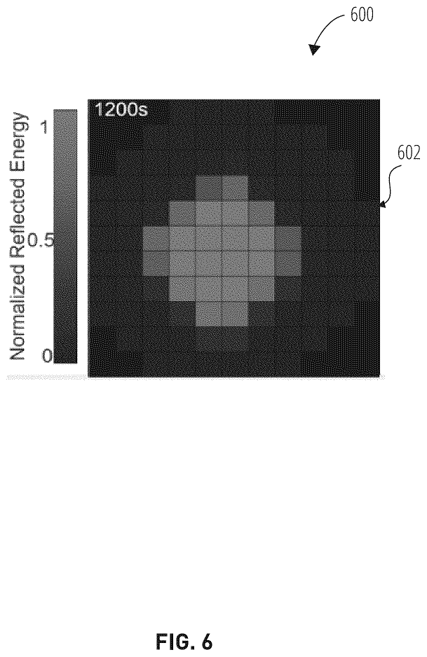

FIG. 6 is a graph 600 of the normalized reflected energy of a sample 602 over time. The graph 600 shows multiple curves corresponding to different time points during polishing of the sample 602 (e.g., from early stages to 1200 seconds of polishing). The normalized reflected energy is plotted to enable comparison across different time steps.

As polishing progresses, the normalized reflected energy curves shift, showing an increase in the overall reflected energy across the sample surface. That normalization allows for quantitative comparison between scans taken at different times and under different conditions.

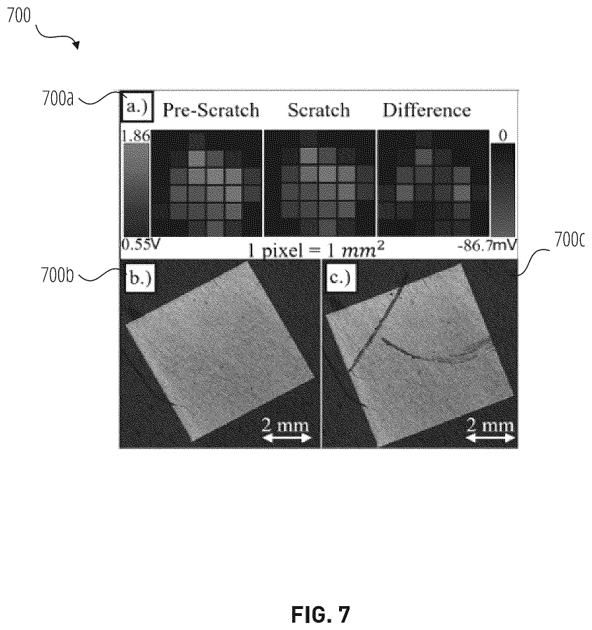

FIG. 7 illustrates a data relationship 700 showing that using the machine, method, and system of the present disclosure, errors in the polishing process can be detected.

FIG. 7 depicts a scratch comparison 700a of a sample, showing a data relationship 700 between surface profile maps taken before and after an intentional scratch is introduced. The map displays the reflected energy at each position across the sample surface, with higher reflected energy values indicating smoother regions.

FIG. 7 depicts a pre-scratch 700b surface profile showing the surface profile map before the scratch is introduced to the sample surface. The pre-scratch 700b map provides a baseline of reflected energy readings across the sample.

FIG. 7 depicts a scratch 700c surface profile showing the effect of the scratch introduced to the sample surface. The scratch 700c is clearly visible as a region of significantly decreased reflected energy, with a difference value indicating the magnitude of the surface roughness change (e.g., approximately −86.7 mV). Each pixel in the maps corresponds to approximately 1 mm². That demonstrates the capability of the machine and method of the present disclosure to detect errors in the polishing process by identifying a decrease in reflected light indicating an increase in surface roughness.

When large scratches are introduced, such as during a polishing failure in which a piece of the sample chips off and contaminates the polishing pad, there is a large increase in surface roughness. That can be detected by a sharp decrease in profiler readings, indicating the process must be stopped, the system cleaned of contaminants, and potentially regressing to a previous polishing step.

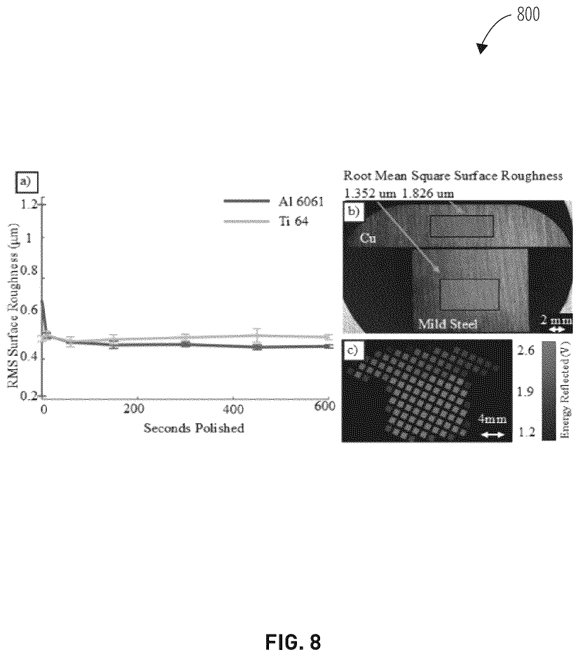

FIG. 8 illustrates a data relationship 800 showing a comparison of surface roughness evolution for different materials during polishing. Those figures relate to the illustrative exemplary embodiment described herein.

Section (a) depicts the root mean square (RMS) surface roughness of Aluminum 6061 and Titanium 64 samples as a function of seconds polished. After polishing for ten minutes, there is a distinct difference between the surface roughness of the Aluminum 6061 and Titanium 64 samples. That demonstrates that polishing different compositions results in different surface roughnesses and that the recipe-based approach may not be suitable for all materials.

Section (b) depicts a two-composition sample of mild steel and copper, showing the RMS surface roughness at different regions. The mild steel region exhibits an RMS surface roughness of approximately 1.352 μm, while the copper region exhibits an RMS surface roughness of approximately 1.826 μm, demonstrating an approximately 0.5 μm difference in the root mean square height between the two materials. That difference illustrates that different compositions within a single sample reach different levels of surface roughness under the same polishing conditions.

Section (c) depicts the profiled reflected energies for the two-composition sample, showing the energy reflected at different positions on the sample surface. The reflected energy values correlate with the surface roughness measurements, confirming that the spectral reflectometry approach of the present disclosure can distinguish between regions of different surface roughness on a multi-composition sample.

FIG. illustrates a data relationship 900 showing the surface evolution during a single polishing process, relating to the illustrative exemplary embodiment described herein.

Section (a) depicts a histogram of the reflected energy readings of a molybdenum sample after polishing for 15 seconds with 320 grit SiC, with 30 bins. The histogram shows the distribution of counts versus reflected energy, providing a statistical view of the surface finish uniformity.

Section (b) depicts the readings of a single point on the molybdenum sample over time as it is polished, showing how the reflected energy at a given location increases with polishing time. That demonstrates the temporal evolution of surface smoothness at a specific point.

Section (c) depicts the readings across the whole surface of the molybdenum sample at different time intervals (e.g., 5 s, 30 s, 45 s, 60 s, 120 s, 180 s, 240 s, 480 s, 720 s, 960 s, and 1200 s), presented as spatial maps with each pixel representing approximately 1 mm². Those maps demonstrate how the reflected energy increases across the entire sample surface as polishing progresses, providing a comprehensive view of polishing uniformity.

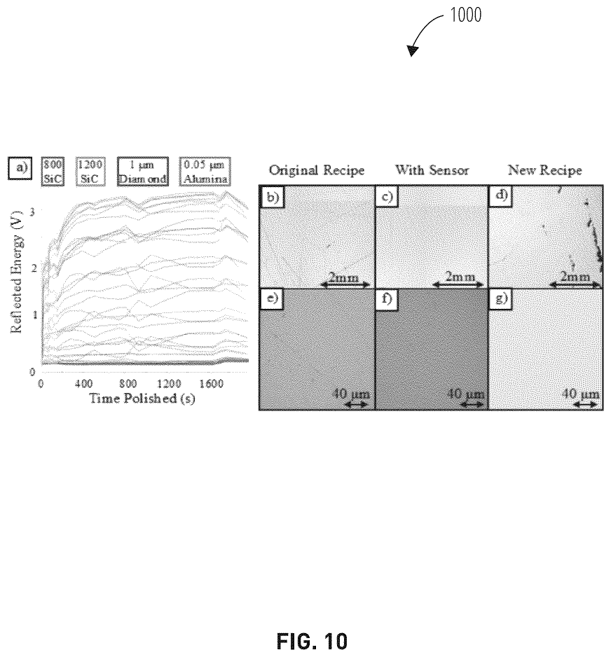

FIG. 10 illustrates a data relationship 1000 relating to a comparison of recipe-based polishing with feedback-controlled polishing according to the present disclosure.

Section (a) depicts a graph of reflected energy versus time polished for the feedback-controlled polishing method, showing the progression through different polishing steps including 800 SiC, 1200 SiC, diamond suspension, and 0.05 μm alumina. The graph shows how the reflected energy changes at each polishing step and how the feedback-controlled method determines when to proceed to the next step based on the stabilization of reflected energy readings rather than a predetermined time.

Sections (b)-(c) depict micrographs showing the surface of a sample polished using the original recipe method and the feedback-controlled method (with sensor), respectively. The micrographs are taken at different magnifications (e.g., 2 mm and 40 μm scales) to illustrate the surface quality achieved by each method.

Sections (d)-(g) depict additional micrographs and surface profile data comparing the original recipe, the feedback-controlled method with sensor, and a new recipe developed based on the feedback data. Those figures demonstrate that the feedback-controlled method can achieve comparable or improved surface quality compared to the fixed-time recipe method, while also enabling the development of new, optimized recipes.

After scanning a sample regularly during polishing, an r×θ×t matrix gives the specular reflectance at point (r, θ) at time t. By graphing those points over time, the progress can be gauged as the surface polish approaches its maximum at a given grit. With in-process measurement of the polish, set or generic recipes are no longer needed. The sample will be polished until ready, as opposed to a set time. That saves time in polishing and creating recipes. Such real-time monitoring capability provides several key advantages over traditional time-based approaches. First, it accounts for natural variations in material properties, ensuring that each sample receives the optimal amount of polishing regardless of composition differences. Second, the system can automatically detect when diminishing returns have been reached at a particular grit level, preventing over-polishing that could damage the surface or waste consumables. Third, by eliminating the trial-and-error phase typically required to develop polishing recipes, the approach significantly reduces preparation time and material costs, particularly valuable when working with expensive or rare materials. The data collected during the feedback-controlled process also creates a comprehensive record of surface evolution, which can be valuable for quality control documentation and process optimization.

The machine, method, and system of the present disclosure eliminate the need for recipes in automated polishing and allows automated polishing for novel materials. In materials characterization laboratories, particularly ones where novel or difficult-to-work-with materials are characterized, the machine and method of the present disclosure can save time and effort of the researchers and technicians during the preparation of their samples.

The feedback loop of the present disclosure can be repeated until there is no change in the reflected light, indicating that a current grit has reached an optimal smoothness. When polishing new compositions for which there is no recipe, or multi-composition samples, applying feedback control of the present disclosure can result in automatic polishing without user input. That feedback loop can be used to develop new recipes when large batches of the same composition are anticipated, as well as validate existing recipes.

The following illustrative exemplary embodiment is provided to further describe the machine, method, and system of the present disclosure. The specific materials, dimensions, parameters, and configurations described herein are provided by way of example only and are not intended to limit the scope of the invention in any way. Those of ordinary skill in the art will appreciate that other materials, dimensions, parameters, and configurations may be used without departing from the spirit and scope of the present disclosure.

In one exemplary embodiment of the present disclosure, the machine 102 was configured as generally shown in FIG. 1A. The light source 108 comprised a 405 nm laser diode mounted in the mount 122 and driven with a laser diode and temperature controller. The beam of light was shaped by the beamshaper 110, which comprised the collimating lens 124, the first plano-convex lens 126, and the second plano-convex lens 128. The shaped beam was then split by the beamsplitter 112, which comprised a 50:50 nonpolarizing beamsplitter cube. The second portion 116 of the beam was directed toward the surface of the material 104, where it reflected off the sample surface. The reflected light was then redirected by the beamsplitter 112 as the first portion 114 through the set of filters 130, which comprised a circular polarization setup (including the linear polarizer 134 and the quarter-wave plate 136) and the bandpass filter 132, before the intensity was measured by the photodetector 118, which comprised an amplified silicon photodetector. The material 104 was attached and aligned with a custom mount on the stage 106, which comprised a motorized X-Y motion stage. The control system 120 comprised an in-house software program connected to a drive controller for the stage 106. The same software program also recorded the photodetector 118 readings through an oscilloscope.

In operation, the machine 102 of the present disclosure reflects the beam of light off the surface of the material 104. Upon reflection, the light separates into diffuse reflectance and specular reflectance, as described with reference to FIG. 2. The rougher the surface, the more the light is diffused, and the specular reflectance lowers. The intensity of the resulting beam after reflection, in which the diffuse reflection is lost, is recorded for each point on the material 104 by moving the material 104 using the stage 106.

In the present exemplary embodiment, single composition samples of the material 104 were cut into 0.25″×0.25″ squares with varying thicknesses out of Titanium 64, Aluminum 6061, and Molybdenum stock using electron discharge machining. The samples were then hot mounted in the center of 1.25″ pucks using phenolic resin in a hot mounting press. A two-composition sample of the material 104 was made by joining a mild steel and a copper cutoff together with cyanoacrylate glue. The two-composition sample was then cold mounted in a 1.25 inch puck with acrylic.

All polishing in the present exemplary embodiment was performed on a semi-automatic polisher. Polishing steps used silicon carbide grinding papers (e.g., 120, 240, 320, 600, 1000 grit), 1 and 3 μm high viscosity polycrystalline diamond suspension with lubricant on a metallographic polishing pad, and 0.05 μm alumina on a nap pad. The semi-automatic polisher comprised a rotating base, upon which the grinding papers or polishing pads were attached. Samples of the material 104 were mounted in a six-sample stage on the rotating head with pistons applying pressure to each. The rotations per minute of both the rotating base and the rotating head were adjustable, as was the direction of rotation (same direction or opposite directions). The pressure of the piston system was adjustable, though it only correlated with the force on each sample.

All direct surface roughness measurements in the present exemplary embodiment were made using a surface profiler. Measurements were taken over the whole sample area, except for the two-component samples, where the scanned areas are shown in FIG. 8 section (b).

To demonstrate the performance of the machine 102 and the method 300 of the present disclosure with different materials, six samples of Aluminum 6061 and Titanium 64 were first planed with 240 SiC. The root mean square surface roughness of each sample was periodically scanned while polishing with 320 SiC, with both top and bottom rotations per minute set to 100 in opposite directions. The pistons were set to a pressure of 40 PSI. The average and standard deviation at each timestep for both materials was determined and is shown in FIG. 8 section (a).

The two-component sample of mild steel and copper was planed with 240 SiC and then polished with 320 SiC. The root mean square surface roughness at different regions of the copper and steel surfaces was measured and is shown in FIG. 8 section (b). The same sample was profiled using the machine 102 of the present disclosure, and the energy reflected at different positions on the sample is shown in FIG. 8 section (c).

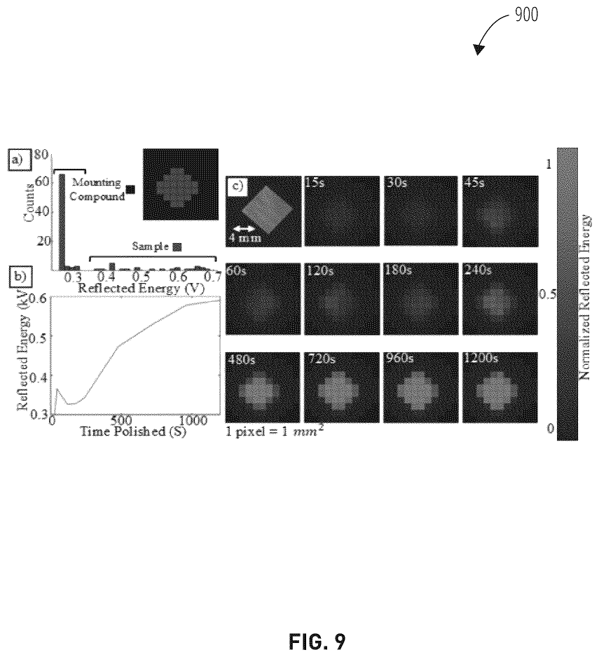

To demonstrate the surface evolution during a single polishing process according to the present disclosure, a molybdenum sample was first planed with 240 grit SiC. The sample was then profiled periodically using the machine 102 while polishing with 320 grit SiC, with both top and bottom of the polisher rotating at 15 RPM in opposite directions. The piston pressure was set to 25 PSI. A histogram of the reflected energy readings after polishing for 15 seconds with 30 bins is shown in FIG. 9 section (a). The readings of a single point on the sample over time as it is polished is shown in FIG. 9 section (b). The readings across the whole surface are shown in FIG. 9 section (c).

To compare recipe-based polishing with the feedback-controlled method 300 of the present disclosure, a recipe for refractory metals from the polisher manufacturer was used as a baseline. The recipe consisted of first planing the sample with 1200 grit alumina, followed by polishing with 800 grit SiC and then 1200 grit SiC for one minute each. The sample was then polished for two minutes using 1 μm polycrystalline diamond with lubricant on a polishing pad. To finish, the sample was polished using 0.05 μm alumina suspension on a nap pad for one minute.

An etchant may optionally be used to remove any embedded abrasive particles between processes. In the present exemplary embodiment, that step was replaced by rinsing with water and visual inspection due to safety considerations associated with etching Molybdenum. Two molybdenum samples of the same size were used. One sample strictly followed the manufacturer's recipe, while the second sample used the same processes but disregarded the prescribed time for each step. Instead, the second sample was regularly profiled using the machine 102 of the present disclosure during polishing, not proceeding to the subsequent step in the recipe until the reflected energy at each point had minimal to no increase over time, in accordance with the method 300 of the present disclosure.

To demonstrate the error detection capability of the present disclosure, an aluminum sample was first polished up to 600 SiC and then intentionally scratched using a steel hex key. The sample surface was profiled using the machine 102 before and after the scratch. The profiler readings before, after, and the difference between the two are shown in 700a-700c. Micrographs were also taken to visually confirm the surface condition.

The results of the present exemplary embodiment demonstrate the capabilities of the machine 102 and the method 300 of the present disclosure. Polishing different compositions resulted in different surface roughnesses. After polishing for ten minutes, there was a distinct difference between the surface roughness of the Aluminum 6061 and the Titanium 64 samples, as shown in FIG. 8 section (a). This difference was further confirmed in the two-composition sample of mild steel and copper, shown in FIG. 8 section (b), where there was approximately a 0.5 μm difference in the root mean square height. This difference is also reflected in the profiled reflected energies shown in FIG. 8 section (c).

As demonstrated by the present disclosure, differences in composition result in different surface roughness values achieved by the same polishing process. That confirms that using a specific surface roughness as a fixed indicator for when to change polishing steps is unreliable without prior knowledge of how a given composition behaves.

As a polishing process removes scratches from the previous grit, surface roughness decreases, which is shown as an increase in the photodetector 118 readings recorded by the control system 120. Once all scratches from the previous grit have been removed, the progress in decreasing surface roughness stops. The machine 102 and method 300 of the present disclosure identify when that plateau occurs, indicating the sample is ready to proceed to the next polishing step. While fixed-time recipes may produce acceptable results when using the same compositions that the recipes were based on, the present disclosure enables automated polishing without user input when polishing new compositions for which there is no recipe, or multi-composition samples. The feedback-controlled method 300 of the present disclosure can also be used to develop new recipes when large batches of the same composition are anticipated, as well as to validate existing recipes.

The error detection capability of the present disclosure was also demonstrated. When large scratches are introduced, such as during a polishing failure, there is a large increase in surface roughness. The machine 102 of the present disclosure detects this condition as a sharp decrease in profiler readings from the photodetector 118, indicating the process must be stopped, the system cleaned of contaminants, and the polishing potentially regressed to a previous step.

The machine, method, and system of the present disclosure provide a number of significant benefits and advantages over conventional recipe-based polishing techniques used in sample preparation.

The present disclosure eliminates the reliance on predetermined, fixed-time polishing recipes. In conventional practice, an operator follows a known or generic recipe that dictates a set polishing time for each grit or polishing solution. The present disclosure replaces that rigid approach with real-time, quantitative feedback based on spectral reflectance measurements from the photodetector 118 and surface roughness maps generated by the control system 120. By monitoring the actual progress of polishing at each step, the machine 102 and method 300 of the present disclosure determine when a given grit has reached its maximum effectiveness, rather than relying on an arbitrary time interval. This results in a more efficient polishing process that adapts to the specific material being polished.

The present disclosure enables automated polishing of novel materials and compositions for which no established recipe exists. Conventional recipe-based methods are limited to materials for which empirical polishing schedules have already been developed. When a new or unfamiliar material is encountered, the conventional approach provides no reliable mechanism for determining optimal polishing parameters. The feedback-controlled method 300 of the present disclosure overcomes this limitation by using real-time reflectance data to guide the polishing process, enabling automated polishing without prior knowledge of how a given composition behaves.

The present disclosure accommodates multi-composition samples in which different regions of the sample may exhibit different polishing behaviors. As demonstrated by the illustrative exemplary embodiment described herein, different materials reach different levels of surface roughness under the same polishing conditions. The spatial mapping capability of the machine 102, in which the control system 120 creates a map of surface roughness based on measured reflective light intensity at different positions on the material 104, enables the operator or automated system to monitor polishing progress at each point on the sample independently. That is particularly advantageous for multi-component samples where different compositions may polish at different rates.

The present disclosure provides the capability to detect errors during the polishing process. Conventional recipe-based methods are typically unable to detect when the surface roughness of a sample increases rather than decreases during polishing, such as when a chip or contaminant introduces scratches to the sample surface. The machine 102 of the present disclosure detects such errors as a sharp decrease in the profiler readings from the photodetector 118, alerting the operator or automated system that the process must be stopped, the system cleaned of contaminants, and the polishing potentially regressed to a previous step. This error detection capability reduces waste, prevents damage to other samples sharing the same polishing pad, and improves overall process reliability.

The present disclosure facilitates the development and validation of new polishing recipes. When large batches of the same composition are anticipated, the feedback-controlled method 300 of the present disclosure can be used to develop optimized, quantitatively derived recipes based on actual reflectance data, rather than relying on empirical trial and error. Additionally, the present disclosure can be used to validate existing recipes by comparing the results achieved by the recipe with the results achieved by the feedback-controlled method.

The present disclosure saves time and effort in materials characterization laboratories. By automating the determination of when to proceed from one polishing step to the next, the machine 102 and method 300 of the present disclosure reduce the need for manual monitoring and subjective judgment by researchers and technicians. The in-process measurement of polishing progress eliminates the need to create and test new recipes through iterative experimentation, and the non-contact optical measurement approach avoids any risk of damaging or contaminating the sample surface during measurement.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

In some embodiments, the light source may emit light at various wavelengths within the range of 180 nm to 850 nm, encompassing both the ultraviolet and visible spectra. The light source may comprise a laser diode, a xenon lamp with beam shaping optics configured to collimate, a deuterium arc lamp with beam shaping optics configured to collimate, a gas laser, a solid state laser, or a femtosecond laser. In certain implementations, the beam shaping optics may comprise optical elements other than or in addition to a collimating lens and plano-convex lenses. The beamsplitter may be configured to split the beam in ratios other than 50:50, and polarizing or other types of beamsplitters may optionally be used. The stage may comprise an X-Y motion stage, an X-Y-Z motion stage, linear translation stages, rotary stages, or other positioning mechanisms capable of precise movement. The photodetector may comprise detector types other than amplified silicon photodetectors, including but not limited to avalanche photodiodes, photomultiplier tubes, or charge-coupled device (CCD) arrays.

In some embodiments, the control system may comprise dedicated hardware, general-purpose computing devices, or combinations thereof. The software for controlling the stage and recording detector readings may be implemented in any suitable programming language or environment. The feedback loop may be implemented in hardware, software, firmware, or combinations thereof.

In certain implementations, the materials to be polished may include refractory metals, alloys, ceramics, composites, or other materials requiring surface preparation for characterization. The polishing equipment may include fully automatic polishers, manual polishers, or other polishing apparatus in addition to the semi-automatic polisher described in the illustrative exemplary embodiment.

What is claimed is:

1. A machine for measuring surface roughness of a material during polishing, the machine comprising:
a stage configured to support the material;
a light source configured to generate a collimated beam of light toward the stage;
a beamshaper configured to shape the beam of light from the light source;
a beamsplitter configured to split the beam of light into a first portion and a second portion, the second portion being directed toward the material on the stage;
a photodetector configured to measure intensity of reflective light from a surface of the material; and
a control system including at least a processor and memory programmed to create a map of surface roughness based on the measured intensity of reflective light at different positions on the material.

2. The machine of claim 1, wherein the stage is movable to scan the material across the light source.

3. The machine of claim 1, wherein a bandpass filter is disposed between the photodetector and the beamsplitter.

4. The machine of claim 3, wherein a set of filters is positioned between the beam splitter and the photodetector, the set of filters comprising the bandpass filter, a linear polarizer, and a quarter-wave plate.

5. The machine of claim 1, wherein the light source is mounted in a mount driven with the light source and a temperature controller.

6. The machine of claim 1, wherein the beamshaper comprises a collimating lens and two plano-convex lenses.

7. The machine of claim 1, wherein the photodetector is an amplified silicon photodetector.

8. The machine of claim 1, wherein the stage is an X-Y motion stage or an X-Y-Z motion stage configured for precise and repeatable movements.

9. The machine of claim 1, wherein the light source emits light having a wavelength between 180 nm and 850 nm.

10. The machine of claim 1, further comprising a circular polarization setup disposed between the beamsplitter and the photodetector.

11. The machine of claim 1, wherein the beamsplitter is configured to direct reflected light from the material toward the photodetector.

12. The machine of claim 1, wherein the control system is configured to compare a first map created after a first polishing step with a second map created after a second polishing step to determine a change in surface roughness.

13. The machine of claim 1, wherein the light source comprises one of: a laser diode; a xenon lamp with beam shaping optics configured to collimate; a deuterium arc lamp with beam shaping optics configured to collimate; a gas laser; a solid state laser; or a femtosecond laser.

14. The machine of claim 1, wherein the light source is a 180 nm to 850 nm light source.

15. A method for automated preparation of a material for material characterization, the method comprising:
polishing a surface of the material using a first grit;
measuring a surface roughness of the surface of the material using reflective light to create a first map;
polishing the surface of the material using a second grit;
measuring the surface roughness of the surface of the material after polishing with the second grit to create a second map; and
comparing the first map and the second map to determine whether there is a change in reflected light.

16. The method of claim 15, further comprising repeating the polishing and measuring steps until there is no change in the reflected light, indicating that a current grit has reached an optimal smoothness.

17. The method of claim 15, wherein measuring the surface roughness comprises:
directing a laser beam toward the surface and measuring intensity of specular reflectance from the surface; and
scanning the surface at a plurality of different positions to create a spatial map of surface roughness.

18. The method of claim 15, further comprising detecting an error in the polishing process by identifying a decrease in reflected light indicating an increase in surface roughness.

19. The method of claim 15, wherein comparing the first map and the second map comprises creating an r×θ×t matrix representing specular reflectance at position (r, θ) at time t.

20. The method of claim 15, wherein the method is performed without following a predetermined recipe for polishing time, and wherein progression to the second grit is determined based on the comparison of the first map and the second map.
